(19) United States
(12) Patent Application Publication
(10) Pub. No.: US 2022/0164723 A1
(43) Pub. Date: May 26, 2022

(54) METHOD FOR DETERMINING BOARDING INFORMATION, ELECTRONIC DEVICE, AND STORAGE MEDIUM

(71) Applicant: Beijing Baidu Netcom Science Technology Co., Ltd., BEIJING (CN)

(72) Inventors: Yueshun Qu, Beijing (CN); Zhen Zhang, Beijing (CN)

(21) Appl. No.: 17/668,978

(22) Filed: Feb. 10, 2022

(30) Foreign Application Priority Data
Apr. 19, 2021 (CN) 202110418559.6

(51) Int. Cl. G06Q 10/04; G06Q 50/30

(52) U.S. Cl. CPC G06Q 10/047; G06Q 50/30

(57) ABSTRACT

A method for determining boarding information, an electronic device, and a storage medium, which relate to the field of online car-hailing, are provided. The method includes: acquiring passenger trajectory data and driver trajectory data of a target itinerary; obtaining boarding trajectory data based on the passenger trajectory data and the driver trajectory data; and determining an actual boarding point of the target itinerary from the boarding trajectory data, based on speeds of respective track points in the boarding trajectory data. According to the solution, the accuracy of determining the actual boarding point can be improved.

### CROSS-REFERENCE TO RELATED APPLICATION

This application claims priority to Chinese patent application No. 202110418559.6, filed on Apr. 19, 2021, which is hereby incorporated by reference in its entirety.

### TECHNICAL FIELD

The present disclosure relates to the field of data processing technology, and in particular, to the field of online car-hailing.

### BACKGROUND

With the development of Internet technology, the application of online car-hailing has become more and more widespread. In the process of providing an online car-hailing service, a server will recommend a boarding point for a passenger who has placed an order based on the location of the passenger, so as to facilitate the passenger to board and a driver to park, and to improve the experience of both the driver and the passenger.

### SUMMARY

A method and apparatus for determining boarding information, an electronic device, and a storage medium are provided by the present disclosure.

According to one aspect of the present disclosure, there is provided a method for determining boarding information, which includes:

acquiring passenger trajectory data and driver trajectory data of a target itinerary;

obtaining boarding trajectory data based on the passenger trajectory data and the driver trajectory data; and

determining an actual boarding point of the target itinerary from the boarding trajectory data, based on speeds of respective track points in the boarding trajectory data.

According to another aspect of the present disclosure, there is provided an electronic device, which includes:

at least one processor; and

a memory communicatively connected with the at least one processor, wherein

the memory stores instructions executable by the at least one processor, and the instructions, when executed by the at least one processor, enable the at least one processor to perform the method in any one of embodiments of the present disclosure.

According to another aspect of the present disclosure, there is provided a non-transitory computer-readable storage medium storing computer instructions, wherein the computer instructions, when executed by a computer, cause the computer to perform the method in any one of the embodiments of the present disclosure.

It should be understood that the content described in this section is not intended to limit the key or important features of the embodiments of the present disclosure, nor is it intended to limit the scope of the present disclosure. Other features of the present disclosure will be easily understood through the following description.

### BRIEF DESCRIPTION OF THE DRAWINGS

The drawings are used to better understand the solution and do not constitute a limitation to the present disclosure, wherein:

FIG. 1 is a schematic diagram of a method for determining boarding information provided by an embodiment of the present disclosure;

FIG. 2 is a schematic diagram of a method for determining boarding information provided by another embodiment of the present disclosure;

FIG. 3 is a schematic diagram of an apparatus for determining boarding information provided by an embodiment of the present disclosure;

FIG. 4 is a schematic diagram of an apparatus for determining boarding information provided by another embodiment of the present disclosure; and

FIG. 5 is a block diagram of an electronic device for implementing a method for determining boarding information according to an embodiment of the present disclosure.

### DETAILED DESCRIPTION

Exemplary embodiments of the present disclosure are described below in combination with the drawings, including various details of the embodiments of the present disclosure to facilitate understanding, which should be considered as exemplary only. Thus, those of ordinary skill in the art should realize that various changes and modifications can be made to the embodiments described here without departing from the scope and spirit of the present disclosure. Likewise, descriptions of well-known functions and structures are omitted in the following description for clarity and conciseness.

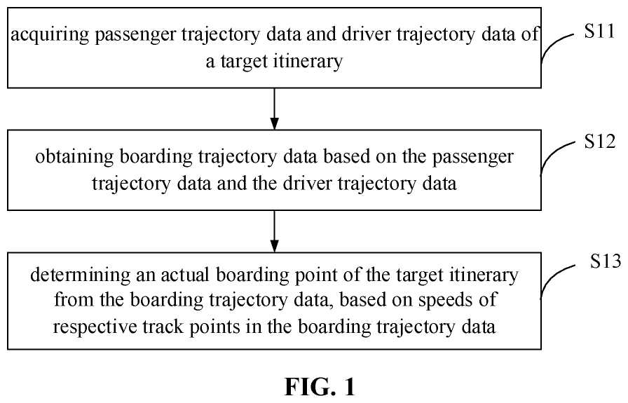

FIG. 1 shows a schematic diagram of a method for determining boarding information provided by an embodiment of the present disclosure. As shown in FIG. 1, the method includes:

S11, acquiring passenger trajectory data and driver trajectory data of a target itinerary;

S12, obtaining boarding trajectory data based on the passenger trajectory data and the driver trajectory data; and

S13, determining an actual boarding point of the target itinerary from the boarding trajectory data, based on speeds of respective track points in the boarding trajectory data.

According to the solution of the present disclosure, the boarding trajectory data is obtained based on the trajectory data of both the passenger and the driver, and the actual boarding point is determined according to speeds of respective track points in the boarding trajectory data. Therefore, the accuracy of determining the actual boarding point can be improved, thereby improving the evaluation effect of the online car-hailing service quality.

Illustratively, the above method may be performed by an electronic device such as a car-hailing server. The online car-hailing server can determine the actual boarding point of the target itinerary based on data sent by a passenger end (or a passenger terminal) and a driver end (or a driver terminal) corresponding to the target itinerary.

Illustratively, the target itinerary may be one of a plurality of itineraries for evaluating the quality of the online car-hailing service, such as evaluating whether the recommended boarding point is accurate, or may be a real-time itinerary, such as an itinerary that ends at the current moment.

In the embodiment of the present disclosure, the trajectory data, such as passenger trajectory data or driver trajectory data, includes at least one track point. Each track point includes positioning coordinates, such as a latitude and a longitude. In some application scenarios, the track point also has the corresponding speed and/or time.

Illustratively, the aforementioned passenger trajectory data may include track points of the passenger end after the passenger places an order. The aforementioned driver trajectory data may include track points of the driver end after the driver receives the order.

Specifically, the target itinerary can include the following processes: recommendation of a boarding point, a passenger inputting a destination, the passenger placing an order, a driver receiving the order, meeting of the driver and the passenger (that is, the driver drives a car to the recommended boarding point to pick up the passenger, and the passenger goes to the recommended boarding point), the passenger getting on the car, the start of driving, the end of driving, and the passenger getting off the car. The aforementioned passenger trajectory data may include trajectory data of a process from the passenger placing an order to the start of driving, the end of driving, or the passenger getting off the car, or the like. The aforementioned driver trajectory data may include trajectory data of a process from the driver receiving the order to the start of driving, the end of driving, or the passenger getting off the bus, or the like.

Illustratively, it is also possible to filter track points of the passenger end after the passenger places an order based on the passenger's starting point or the track point when the passenger places the order, to obtain passenger trajectory data; and filter track points of the driver end after the driver receives the order, to obtain the driver trajectory data. As an example, among a plurality of track points of the passenger end after an order is placed on the passenger end, the starting point of the passenger or a track point in a preset range around a track point of the passenger when placing the order may be selected as a track point in the passenger trajectory data. Correspondingly, among the plurality of track points of the driver end after the driver receives the order, the starting point of the passenger or a track point in a preset range around a track point of the passenger when placing the order may be selected as a track point in the driver trajectory data. Herein, the preset range is, for example, a range within 50 meters or 100 meters centered on the starting point of the passenger or the track point of the passenger when placing the order.

According to the technical solution of the present disclosure, the boarding trajectory data is obtained based on the trajectory data of both the passenger and the driver, and the actual boarding point is determined according to speeds of respective trajectory points in the boarding trajectory data. Therefore, the accuracy of determining the actual boarding point can be improved, thereby improving the evaluation effect of online car-hailing service quality.

In an exemplary embodiment, the above step S12, obtaining the boarding trajectory data based on the passenger trajectory data and the driver trajectory data, includes:

determining an intersection of the passenger trajectory data and the driver trajectory data; and

obtaining the boarding trajectory data based on the intersection.

For example, the intersection of the passenger trajectory data and the driver trajectory data is used as boarding trajectory data. That is to say, track points that exist in both the passenger trajectory data and the driver trajectory data are used as trajectory points in the boarding trajectory data.

It should be noted that when determining the intersection, the intersection can be obtained based on coordinates of each track point, or based on the coordinates of each track point and its corresponding speed and/or time. For example, in some scenarios, track points with the same coordinates in the passenger trajectory data and the driver trajectory data can be used as a track points in the intersection; in other scenarios, track points with the same coordinates, speed and/or time in the passenger trajectory data and the driver trajectory data can be used as a track point in the intersection.

Generally speaking, based on the intersection of the passenger trajectory data and the driver trajectory data, the obtained boarding trajectory data includes at least one track point where the passenger and the driver meet. Based on this, it is possible to effectively limit the range of determining the actual boarding point and improve the efficiency of determining the actual boarding point.

Illustratively, other specific track points may also be combined to obtain the above-mentioned boarding trajectory data. Specifically, the obtaining the boarding trajectory data based on the intersection, includes:

acquiring a driver arrival track point and a passenger boarding track point; and

obtaining the boarding trajectory data based on the intersection, the driver arrival track point and the passenger boarding track point.

For example, the above intersection, the driver arrival track point, and the passenger boarding track point are added to the boarding trajectory data.

Herein, the driver arrival track point can be a track point of the driver end when the driver confirms arrival of the recommended boarding point. The passenger boarding track point may be a track point of the driver end or the passenger end when the driver or passenger confirms that the passenger has boarded.

According to the above implementation, the accurate track point information related to the meeting between the driver and the passenger is added to the boarding track data, which can avoid the omission of an important track point, and improve the accuracy of the boarding track data, thereby improving the accuracy of determining the actual boarding point.

In an exemplary embodiment, the above step S13, the determining the actual boarding point of the target itinerary from the boarding trajectory data, based on the speeds of the respective track points in the boarding trajectory data, includes:

determining at least one target track point in the boarding trajectory data based on the speeds of the respective track points in the boarding trajectory data, wherein a speed of the target track point is less than or equal to a threshold; and

determining the actual boarding point of the target itinerary from the at least one target track point.

Herein, the speed of the track point can be an instantaneous speed collected by a speed sensor on the passenger end or the driver end.

Illustratively, the above threshold may be zero.

According to the above embodiment, the actual boarding point can be obtained based on a track point where speeds of the driver and the passenger is less than or equal to the threshold value, and the accuracy of the actual boarding point can be improved.

Illustratively, if the number of target track points is multiple, the actual boarding point may be determined from at least one target track point based on a predetermined rule. For example, it is determined whether the target track point is the actual boarding point based on whether the target track point is on a roadside, or a center point is determined from a plurality of target track points as the actual boarding point.

In practical applications, it is also possible to perform operations such as clustering and road-binding according to the distribution of respective track points, to determine an actual boarding point. Here, road-binding may refer to determining a point on a roadside corresponding to a certain track point, for example, determining a positioning point on the roadside closest to a certain track point. For example, it is possible to perform road-binding on a plurality of target track points to obtain a plurality of candidate points on the roadside corresponding to the plurality of target track points; then determine a center point from the plurality of candidate points as the actual boarding point. Or after road-binding, the plurality of candidate points on the roadside are clustered to obtain center points of a plurality of track point clusters, and then the actual boarding point is selected from them.

In an exemplary embodiment, the determining the actual boarding point of the target itinerary from the at least one target track point, includes:

clustering the at least one target track point to obtain at least one track point cluster; and

obtaining the actual boarding point of the target itinerary based on a center of the at least one track point cluster.

Illustratively, at least one clustering algorithm such as DBSCAN (Density-Based Spatial Clustering of Applications with Noise), K-means (K-means Clustering Algorithm), etc. can be used, to clusters at least one target track point.

Illustratively, the actual boarding point may be determined from a center of at least one track point cluster based on a preset rule.

According to the above embodiment, clustering at least one target track point to obtain the actual boarding point can improve the accuracy of the actual boarding point.

Illustratively, obtaining the actual boarding point of the target itinerary based on the center of the at least one track point cluster, includes:

performing a road-binding operation on the center of the at least one track point cluster, to obtain at least one candidate point; and

determining the actual boarding point of the target itinerary from the at least one candidate point.

Herein, the actual boarding point of the target itinerary can be determined from at least one candidate point according to a preset rule.

According to the above embodiment, after clustering at least one track point with a speed less than or equal to a threshold, road-binding is performed on a center of a track point cluster, so that the final determined actual boarding point can be a positioning point on a roadside, which makes the actual boarding point conform to the actual situation, and improve the accuracy of the actual boarding point.

A specific application example of the embodiments of the present disclosure is provided below. In this application example, the actual boarding point can be used to determine the accuracy of the recommended boarding point and evaluate the recommendation effect.

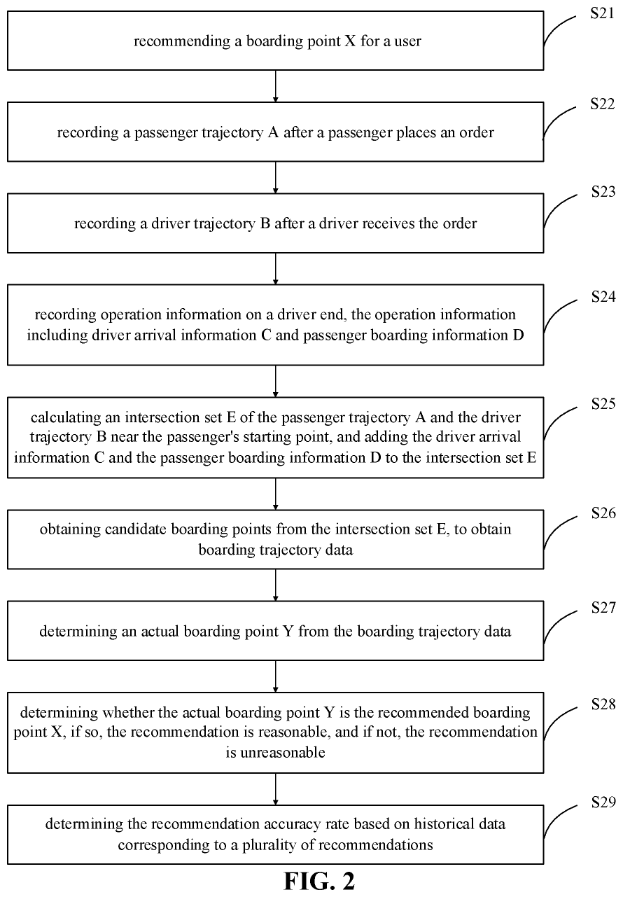

As shown in FIG. 2, the method provided by the embodiment of the present disclosure may include the following:

S21, recommending a boarding point X for a user;

S22, recording a passenger trajectory A after a passenger places an order, wherein the passenger trajectory A includes at least one passenger track point, and each passenger track point includes at least one of time, coordinates, a speed, and other information;

S23, recording a driver trajectory B after a driver receives the order, wherein the driver trajectory B includes at least one driver track point, and each driver track point includes at least one of information such as time, coordinates, a speed, and other information;

S24, recording operation information on a driver end, the operation information including:

driver arrival information C, including a track point of the driver end when the driver arrives; and

passenger boarding information D, including a track point of the driver end when the driver confirms that the passenger has boarded,

wherein the track point of the driver end includes at least one of an operation type, time, coordinates, a speed and other information;

S25, calculating an intersection set E of the trajectory A and the trajectory B near the passenger's starting point, and adding the information C and the information D to the set E;

S26, obtaining candidate boarding points from the set E, to obtain boarding trajectory data, wherein

specifically, a speed of each track point in the set E can be combined, if the speed=0, the track point is determined as a candidate boarding point F;

S27, determining an actual boarding point Y from the boarding trajectory data, wherein

if there is only one candidate boarding point F, the candidate boarding point F is the actual vehicle point Y; if there are a plurality of candidate boarding points F, clustering and road-binding operations are performed according to the distribution of a plurality of points F, to obtain the actual boarding point Y;

S28, determining whether the actual boarding point Y is the recommended boarding point X, if so, the recommendation is reasonable, and if not, the recommendation is unreasonable; and

S29, determining the recommendation accuracy rate based on historical data corresponding to a plurality of recommendations, wherein

recommendation accuracy=number of reasonable recommendations/total number of recommendations; the recommendation accuracy rate can be used to measure the pros and cons of the entire recommendation effect, and the higher the recommendation accuracy rate, the better the recommendation effect.

According to the method of the embodiment of the present disclosure, the boarding trajectory data is obtained based on the trajectory data of both the passenger and the driver, and the actual boarding point is determined according to the speed of each trajectory point in the boarding trajectory data. Therefore, the accuracy of the actual boarding point can be improved, thereby improving the evaluation effect of the quality of the online car-hailing service.

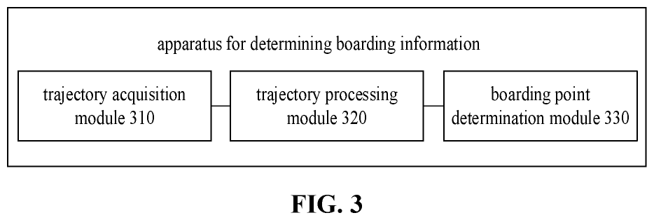

As an implementation of the above methods, the present disclosure also provides an apparatus for determining boarding information. As shown in FIG. 3, the apparatus includes:

a trajectory acquisition module 310 configured for acquiring passenger trajectory data and driver trajectory data of a target itinerary;

a trajectory processing module 320 configured for obtaining boarding trajectory data based on the passenger trajectory data and the driver trajectory data; and

a boarding point determination module 330 configured for determining an actual boarding point of the target itinerary from the boarding trajectory data, based on speeds of respective track points in the boarding trajectory data.

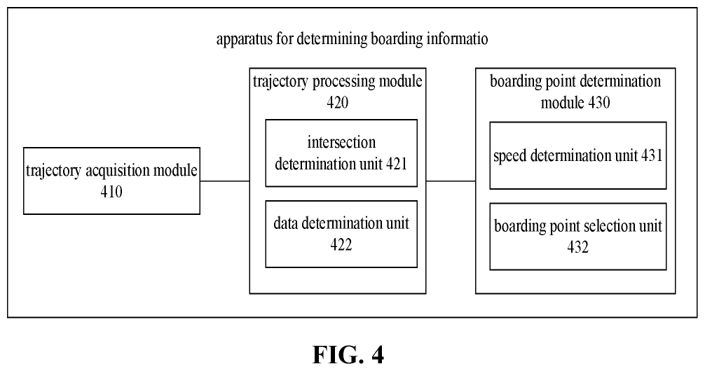

Illustratively, as shown in FIG. 4, a trajectory acquisition module 410, a trajectory processing module 420 and a boarding point determination module 430 shown in FIG. 4 are modules same as or similar to the trajectory acquisition module 310, the trajectory processing module 320 and the boarding point determination module 330 shown in FIG. 3, respectively. The trajectory processing module 420 includes:

an intersection determination unit 421 configured for determining an intersection of the passenger trajectory data and the driver trajectory data; and

a data determination unit 422 configured for obtaining the boarding trajectory data based on the intersection.

As shown in FIG. 4, the data determination unit 422 is further configured for:

acquiring a driver arrival track point and a passenger boarding track point; and

obtaining the boarding trajectory data based on the intersection, the driver arrival track point and the passenger boarding track point.

As shown in FIG. 4, the boarding point determination module 430 includes:

a speed determination unit 431 configured for determining at least one target track point in the boarding trajectory data based on the speeds of the respective track points in the boarding trajectory data, wherein a speed of the target track point is less than or equal to a threshold; and

a boarding point selection unit 432 configured for determining the actual boarding point of the target itinerary from the at least one target track point.

Illustratively, the boarding point selection unit 432 is further configured for:

clustering the at least one target track point to obtain at least one track point cluster; and

obtaining the actual boarding point of the target itinerary based on a center of the at least one track point cluster.

Illustratively, the boarding point selection unit 432 is further configured for:

performing a road-binding operation on the center of the at least one track point cluster, to obtain at least one candidate point; and

determining the actual boarding point of the target itinerary from the at least one candidate point.

The functions of the units, modules or sub-modules in the apparatuses in the embodiments of the present disclosure may refer to the corresponding descriptions in the foregoing method embodiments, and details are not repeated here.

According to embodiments of the present disclosure, the present disclosure also provides an electronic device, a readable storage medium, and a computer program product.

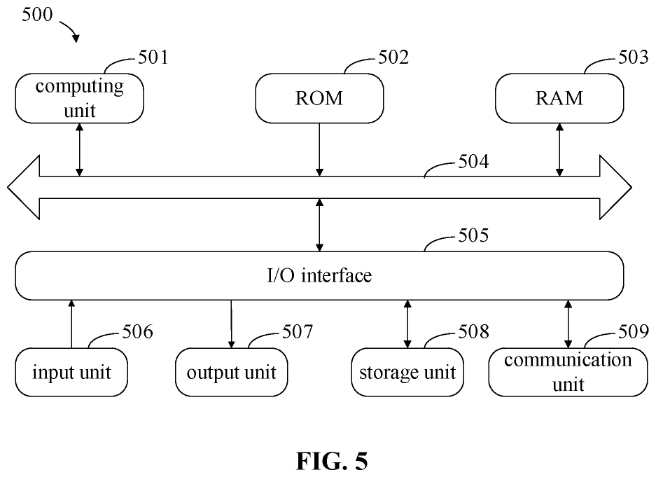

FIG. 5 shows a schematic diagram of an example electronic device 500 configured for implementing the embodiment of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as a personal digital assistant, a cellular telephone, a smart phone, a wearable device, and other similar computing devices. The components shown herein, their connections and relationships, and their functions are by way of example only and are not intended to limit the implementations of the present disclosure described and/or claimed herein.

As shown in FIG. 5, the electronic device 500 includes a computing unit 501 that may perform various suitable actions and processes in accordance with computer programs stored in a read only memory (ROM) 502 or computer programs loaded from a storage unit 508 into a random access memory (RAM) 503. In the RAM 503, various programs and data required for the operation of the electronic device 500 may also be stored. The computing unit 501, the ROM 502 and the RAM 503 are connected to each other through a bus 504. An input/output (I/O) interface 505 is also connected to the bus 504.

A plurality of components in the electronic device 500 are connected to the I/O interface 505, including: an input unit 506, such as a keyboard, a mouse, etc.; an output unit 507, such as various types of displays, speakers, etc.; a storage unit 508, such as a magnetic disk, an optical disk, etc.; and a communication unit 509, such as a network card, a modem, a wireless communication transceiver, etc. The communication unit 509 allows the electronic device 500 to exchange information/data with other devices over a computer network, such as the Internet, and/or various telecommunications networks.

The computing unit 501 may be various general purpose and/or special purpose processing assemblies having processing and computing capabilities. Some examples of the computing unit 501 include, but are not limited to, a central processing unit (CPU), a graphics processing unit (GPU), various specialized artificial intelligence (AI) computing chips, various computing units running machine learning model algorithms, a digital signal processor (DSP), and any suitable processor, controller, microcontroller, etc. The computing unit 501 performs various methods and processes described above, such as the route recommendation method. For example, in some embodiments, the route recommendation method may be implemented as computer software programs that are physically contained in a machine-readable medium, such as the storage unit 508. In some embodiments, some or all of the computer programs may be loaded into and/or installed on the electronic device 500 via the ROM 502 and/or the communication unit 509. In a case where the computer programs are loaded into the RAM 503 and executed by the computing unit 501, one or more of steps of the route recommendation method may be performed. Alternatively, in other embodiments, the computing unit 501 may be configured to perform the route recommendation method in any other suitable manner (e.g., by means of a firmware).

Various embodiments of the systems and techniques described herein above may be implemented in a digital electronic circuit system, an integrated circuit system, a field programmable gate array (FPGA), an application specific integrated circuit (ASIC), an application specific standard product (ASSP), a system on a chip (SOC), a load programmable logic device (CPLD), a computer hardware, a firmware, a software, and/or a combination thereof. These various implementations may include an implementation in one or more computer programs, which can be executed and/or interpreted on a programmable system including at least one programmable processor; the programmable processor may be a dedicated or general-purpose programmable processor and capable of receiving and transmitting data and instructions from and to a storage system, at least one input device, and at least one output device.

The program codes for implementing the methods of the present disclosure may be written in any combination of one or more programming languages. These program codes may be provided to a processor or controller of a general purpose computer, a special purpose computer, or other programmable data processing apparatus such that the program codes, when executed by the processor or controller, enable the functions/operations specified in the flowchart and/or the block diagram to be performed. The program codes may be executed entirely on a machine, partly on a machine, partly on a machine as a stand-alone software package and partly on a remote machine, or entirely on a remote machine or server.

In the context of the present disclosure, the machine-readable medium may be a tangible medium that may contain or store programs for using by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include one or more wire-based electrical connection, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination thereof.

In order to provide an interaction with a user, the system and technology described here may be implemented on a computer having: a display device (e. g., a cathode ray tube (CRT) or a liquid crystal display (LCD) monitor) for displaying information to the user; and a keyboard and a pointing device (e. g., a mouse or a trackball), through which the user can provide an input to the computer. Other kinds of devices can also provide an interaction with the user. For example, a feedback provided to the user may be any form of sensory feedback (e.g., visual feedback, auditory feedback, or tactile feedback); and an input from the user may be received in any form, including an acoustic input, a voice input or a tactile input.

The systems and techniques described herein may be implemented in a computing system (e.g., as a data server) that may include a background component, or a computing system (e.g., an application server) that may include a middleware component, or a computing system (e.g., a user computer having a graphical user interface or a web browser through which a user may interact with embodiments of the systems and techniques described herein) that may include a front-end component, or a computing system that may include any combination of such background components, middleware components, or front-end components. The components of the system may be connected to each other through a digital data communication in any form or medium (e.g., a communication network). Examples of the communication network may include a local area network (LAN), a wide area network (WAN), and the Internet.

The computer system may include a client and a server. The client and the server are typically remote from each other and typically interact via the communication network. The relationship of the client and the server is generated by computer programs running on respective computers and having a client-server relationship with each other.

It should be understood that the steps can be reordered, added or deleted using the various flows illustrated above. For example, the steps described in the present disclosure may be performed concurrently, sequentially or in a different order, so long as the desired results of the technical solutions disclosed in the present disclosure can be achieved, and there is no limitation herein.

In the technical solutions of the present disclosure, the acquisition, storage, and application of personal information of users involved are in compliance with relevant laws and regulations, and do not violate public order and good customs.

The above-described specific embodiments do not limit the scope of the present disclosure. It will be apparent to those skilled in the art that various modifications, combinations, sub-combinations and substitutions are possible, depending on design requirements and other factors. Any modifications, equivalent substitutions, and improvements within the spirit and principles of the present disclosure are intended to be included within the scope of the present disclosure.

What is claimed is:

1. A method for determining boarding information, comprising:
acquiring passenger trajectory data and driver trajectory data of a target itinerary;
obtaining boarding trajectory data based on the passenger trajectory data and the driver trajectory data; and
determining an actual boarding point of the target itinerary from the boarding trajectory data, based on speeds of respective track points in the boarding trajectory data.

2. The method of claim 1, wherein the obtaining the boarding trajectory data based on the passenger trajectory data and the driver trajectory data, comprises:
determining an intersection of the passenger trajectory data and the driver trajectory data; and
obtaining the boarding trajectory data based on the intersection.

3. The method of claim 2, wherein the obtaining the boarding trajectory data based on the intersection, comprises:
acquiring a driver arrival track point and a passenger boarding track point; and
obtaining the boarding trajectory data based on the intersection, the driver arrival track point and the passenger boarding track point.

4. The method of claim 1, wherein the determining the actual boarding point of the target itinerary from the boarding trajectory data, based on the speeds of the respective track points in the boarding trajectory data, comprises:
determining at least one target track point in the boarding trajectory data based on the speeds of the respective track points in the boarding trajectory data, wherein a speed of the target track point is less than or equal to a threshold; and
determining the actual boarding point of the target itinerary from the at least one target track point.

5. The method of claim 4, wherein the determining the actual boarding point of the target itinerary from the at least one target track point, comprises:
clustering the at least one target track point to obtain at least one track point cluster; and
obtaining the actual boarding point of the target itinerary based on a center of the at least one track point cluster.

6. The method of claim 5, wherein the obtaining the actual boarding point of the target itinerary based on the center of the at least one track point cluster, comprises:
performing a road-binding operation on the center of the at least one track point cluster, to obtain at least one candidate point; and
determining the actual boarding point of the target itinerary from the at least one candidate point.

7. The method of claim 2, wherein the determining the actual boarding point of the target itinerary from the boarding trajectory data, based on the speeds of the respective track points in the boarding trajectory data, comprises:
determining at least one target track point in the boarding trajectory data based on the speeds of the respective track points in the boarding trajectory data, wherein a speed of the target track point is less than or equal to a threshold; and
determining the actual boarding point of the target itinerary from the at least one target track point.

8. The method of claim 3, wherein the determining the actual boarding point of the target itinerary from the boarding trajectory data, based on the speeds of the respective track points in the boarding trajectory data, comprises:
determining at least one target track point in the boarding trajectory data based on the speeds of the respective track points in the boarding trajectory data, wherein a speed of the target track point is less than or equal to a threshold; and
determining the actual boarding point of the target itinerary from the at least one target track point.

9. An electronic device, comprising:
at least one processor; and
a memory communicatively connected with the at least one processor,
wherein the memory stores instructions executable by the at least one processor, and the instructions, when executed by the at least one processor, enable the at least one processor to perform operations of:
acquiring passenger trajectory data and driver trajectory data of a target itinerary;
obtaining boarding trajectory data based on the passenger trajectory data and the driver trajectory data; and
determining an actual boarding point of the target itinerary from the boarding trajectory data, based on speeds of respective track points in the boarding trajectory data.

10. The electronic device of claim 9, wherein the obtaining the boarding trajectory data based on the passenger trajectory data and the driver trajectory data, comprises:
determining an intersection of the passenger trajectory data and the driver trajectory data; and
obtaining the boarding trajectory data based on the intersection.

11. The electronic device of claim 10, wherein the obtaining the boarding trajectory data based on the intersection, comprises:
acquiring a driver arrival track point and a passenger boarding track point; and
obtaining the boarding trajectory data based on the intersection, the driver arrival track point and the passenger boarding track point.

12. The electronic device of claim 9, wherein the determining the actual boarding point of the target itinerary from the boarding trajectory data, based on the speeds of the respective track points in the boarding trajectory data, comprises:
determining at least one target track point in the boarding trajectory data based on the speeds of the respective track points in the boarding trajectory data, wherein a speed of the target track point is less than or equal to a threshold; and
determining the actual boarding point of the target itinerary from the at least one target track point.

13. The electronic device of claim 12, wherein the determining the actual boarding point of the target itinerary from the at least one target track point, comprises:
clustering the at least one target track point to obtain at least one track point cluster; and
obtaining the actual boarding point of the target itinerary based on a center of the at least one track point cluster.

14. The electronic device of claim 13, wherein the obtaining the actual boarding point of the target itinerary based on the center of the at least one track point cluster, comprises:
performing a road-binding operation on the center of the at least one track point cluster, to obtain at least one candidate point; and
determining the actual boarding point of the target itinerary from the at least one candidate point.

15. A non-transitory computer-readable storage medium storing computer instructions, wherein the computer instructions, when executed by a computer, cause the computer to perform operations of:
acquiring passenger trajectory data and driver trajectory data of a target itinerary;
obtaining boarding trajectory data based on the passenger trajectory data and the driver trajectory data; and
determining an actual boarding point of the target itinerary from the boarding trajectory data, based on speeds of respective track points in the boarding trajectory data.

16. The non-transitory computer-readable storage medium of claim 15, wherein the obtaining the boarding trajectory data based on the passenger trajectory data and the driver trajectory data, comprises:
determining an intersection of the passenger trajectory data and the driver trajectory data; and
obtaining the boarding trajectory data based on the intersection.

17. The non-transitory computer-readable storage medium of claim 16, wherein the obtaining the boarding trajectory data based on the intersection, comprises:
acquiring a driver arrival track point and a passenger boarding track point; and
obtaining the boarding trajectory data based on the intersection, the driver arrival track point and the passenger boarding track point.

18. The non-transitory computer-readable storage medium of claim 15, wherein the determining the actual boarding point of the target itinerary from the boarding trajectory data, based on the speeds of the respective track points in the boarding trajectory data, comprises:
determining at least one target track point in the boarding trajectory data based on the speeds of the respective track points in the boarding trajectory data, wherein a speed of the target track point is less than or equal to a threshold; and
determining the actual boarding point of the target itinerary from the at least one target track point.

19. The non-transitory computer-readable storage medium of claim 18, wherein the determining the actual boarding point of the target itinerary from the at least one target track point, comprises:
clustering the at least one target track point to obtain at least one track point cluster; and
obtaining the actual boarding point of the target itinerary based on a center of the at least one track point cluster.

20. The non-transitory computer-readable storage medium of claim 19, wherein the obtaining the actual boarding point of the target itinerary based on the center of the at least one track point cluster, comprises:
performing a road-binding operation on the center of the at least one track point cluster, to obtain at least one candidate point; and
determining the actual boarding point of the target itinerary from the at least one candidate point.
